(19) United States
(12) Patent Application Publication
(10) Pub. No.: US 2026/0080390 A1
(43) Pub. Date: Mar. 19, 2026

(54) INFORMATION PROCESSING DEVICE, INFORMATION PROCESSING METHOD, AND NON-TRANSITORY COMPUTER READABLE STORAGE MEDIUM

(71) Applicant: LY Corporation, Tokyo (JP)

(72) Inventors: Wataru OGAMI, Tokyo (JP); Hidehito GOMI, Tokyo (JP); Shuuji YAMAGUCHI, Tokyo (JP); Hiroaki TAGUCHI, Tokyo (JP)

(21) Appl. No.: 19/229,311

(22) Filed: Jun. 5, 2025

(30) Foreign Application Priority Data
Sep. 19, 2024 (JP) 2024-161595

(51) Int. Cl. G06Q 20/34; G06Q 20/36; G06Q 20/38

(52) U.S. Cl. CPC G06Q 20/3572; G06Q 20/36; G06Q 20/382

(57) ABSTRACT

An information processing device according to the present application includes an issuance processing unit that provides the function of issuing the data card that allows another account to use the data related to a user of an account, to the account to be an issuer of the data card, a management unit that provides the user with the function of managing the wallet that stores the issued data card, and a verification processing unit that provides the function of verifying the data card to another account to be presented with the data card by the user and to be a verifier of the data card.

### CROSS-REFERENCE TO RELATED APPLICATIONS

The present application claims priority to and incorporates by reference the entire contents of Japanese Patent Application No. 2024-161595 filed in Japan on Sep. 19, 2024.

### BACKGROUND OF THE INVENTION

### 1. Field of the Invention

The present invention relates to an information processing device, an information processing method, and an information processing program.

### 2. Description of the Related Art

A technique has been disclosed in which both residents and staff can reduce the burden of procedures at a public office window, shorten the time at the window, and improve the overall efficiency (see JP 2018-139027 A).

However, in the above-described conventional technology, it is not possible to provide useful data such as data for identification confirmation and data for proving the behavior of the person to another user or another service.

### SUMMARY OF THE INVENTION

An information processing device includes an issuance processing unit that provides a function of issuing a data card that allows another account to use the data related to a user of an account, to the account to be an issuer of the data card; a management unit that provides the user with a function of managing a wallet that stores the issued data card; and a verification processing unit that provides a function of verifying the data card to another account to be presented with the data card by the user and to be a verifier of the data card.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an explanatory diagram illustrating an outline of an information processing system according to the embodiment;

FIG. 2 is an explanatory diagram illustrating a case where useful data is made to a data card;

FIG. 3 is an explanatory diagram illustrating an image of easily and safely sharing useful data with a data card;

FIG. 4 is an explanatory diagram illustrating an image of use;

FIG. 5 is an explanatory diagram illustrating an image of data pickup;

FIG. 6 is an explanatory diagram illustrating an image of batch use of data cards;

FIG. 7 is an explanatory diagram illustrating an image of distribution of a data card;

FIG. 8 is an explanatory diagram illustrating an image of formation of a data card utilization market;

FIG. 9 is an explanatory diagram illustrating an image of a template and creation of a card;

FIG. 10 is a diagram illustrating a configuration example of a terminal device according to the embodiment;

FIG. 11 is a diagram illustrating a configuration example of a server device according to the embodiment;

FIG. 12 is a flowchart illustrating a processing procedure according to the embodiment; and

FIG. 13 is a diagram illustrating an example of a hardware configuration.

### DETAILED DESCRIPTION OF THE PREFERRED EMBODIMENTS

Hereinafter, modes (hereinafter, it is described as “the embodiment”) for implementing an information processing device, an information processing method, and an information processing program according to the present application will be described in detail with reference to the drawings. Note that the information processing device, the information processing method, and the information processing program according to the present application are not limited by the embodiment. In the following embodiments, the same parts are denoted by the same reference numerals, and redundant description will be omitted.

### 1. Outline of Information Processing System

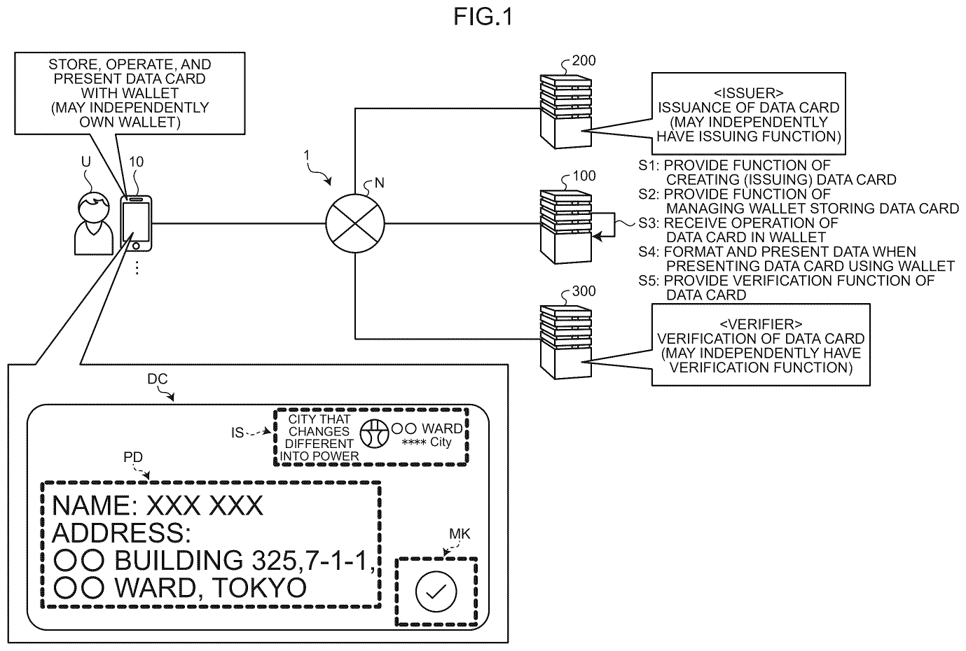

First, an outline of an information processing system according to the embodiment will be described with reference to FIG. 1. FIG. 1 is an explanatory diagram illustrating an outline of an information processing system according to the embodiment. As illustrated in FIG. 1, an information processing system 1 according to the embodiment includes a terminal device 10 and a server device 100. The terminal device 10 and the server device 100 are communicably connected to each other in a wired or wireless manner via a network N. Thus, the terminal device 10 can cooperate with the server device 100. The network N is, for example, a local area network (LAN), a wide area network (WAN), the Internet, or the like.

The terminal device 10 is an information processing device used by a user U (user). For example, the terminal device 10 is a smart device such as a smart phone or a tablet terminal, a personal computer (PC) such as a desktop type or a notebook (laptop) type, a mobile phone such as a feature phone, a personal digital assistant (PDA), a game machine or an AV device having a communication function, an information home/digital home appliance, a car navigation system, or a wearable device such as a smart watch, a head mounted display, smart glasses, or the like. Furthermore, the terminal device 10 may be a house or a building, a car, a home appliance, an electronic device, or the like compatible with Internet of Things (IOT).

In the present embodiment, the terminal device 10 is a smart device such as a smartphone or a tablet terminal used by the user U, and is a portable terminal device capable of communicating with any server device via a wireless communication network such as long term evolution (LTE), a fourth generation (4G), or a fifth generation mobile communication system (5G), Bluetooth (registered trademark), a wireless LAN, or the like. Furthermore, the terminal device 10 includes a screen such as a liquid crystal display and having a touch panel function, and receives various operations on display data such as content from the user U, such as a tap operation, a slide operation, and a scroll operation with a finger, a stylus, or the like. Note that an operation performed on a region of the screen where the content is displayed may be an operation on the content. Furthermore, the terminal device 10 may be not only a smart device but also an information processing device such as a desktop PC or a notebook PC.

The server device 100 is, for example, a computer such as a PC or a blade server, a mainframe, a workstation, or the like. Note that server device 100 may be implemented by cloud computing.

In the present embodiment, the server device 100 is an information processing device that cooperates with the terminal device 10 of each user U and provides an application programming interface (API) service for various applications (hereinafter, an application) and the like and various pieces of data to the terminal device 10 of each user U, and is implemented by a computer, a cloud system, or the like.

Furthermore, the server device 100 may be an information processing device that provides some sort of online service to the terminal device 10 of each user U. For example, the server device 100 may provide, as online services, services such as an Internet connection, a search service, a chat service, an interaction service by voice, image, video, or the like, a social networking service (SNS), an electronic commerce (EC), electronic payment, an online game, online banking, online trading, lodging/ticket reservation, video/music distribution, news, a map, a route search, route guidance, route information, operation information, weather forecast, and the like. In practice, the server device 100 may mediate the online service in cooperation with various servers that provide the online service as described above, or may be in charge of processing the online service.

Note that the server device 100 can acquire user information about the user U. For example, the server device 100 acquires, as the user information, information (attribute information) regarding attributes of the user U such as gender, age, and residential area of the user U. In addition, the server device 100 can acquire information about attributes of the user U, such as demographic attribute, psychographic attribute, geographic attribute, and behavioral attribute. Furthermore, the server device 100 may acquire, as the user information, a segment to which the user U belongs in the field of marketing, persona (person image), or the like. Then, the server device 100 stores and manages information (attribute information) regarding the attribute of the user U together with identification information (user ID and the like) indicating the user U.

In addition, the server device 100 acquires various types of history information (log data) indicating the behavior of the user U from the terminal device 10 of the user U or from various servers or the like based on the user ID or the like. For example, the server device 100 acquires a location history, which is a history of the location and date and time of the user U, from the terminal device 10. In addition, the server device 100 acquires a search history, which is a history of the search query input by the user U, from the search server (search engine). In addition, the server device 100 acquires a browsing history, which is a history of content browsed by the user U, from the content server. Furthermore, the server device 100 acquires a purchase history (settlement history), which is a history of product purchase and settlement processing of the user U, from the e-commerce server or the settlement processing server. In addition, the server device 100 may acquire a display history which is a history of showing by the user U on the marketplace or a sales history from the e-commerce server or the settlement processing server. Furthermore, the server device 100 acquires a post history, which is a history of the post by the user U, from a post server or an SNS server that provides a word-of-mouth posting service. Note that the above-described various servers and the like may be the server device 100 itself. That is, the server device 100 may function as the above-described various servers and the like.

Furthermore, the number of devices included in the information processing system 1 illustrated in FIG. 1 is not limited to the illustrated number. For example, in FIG. 1, only one terminal device 10 is illustrated for simplification of illustration, but this is merely an example and the present disclosure is not limited to this, and two or more terminal devices may be provided.

Furthermore, the information processing system 1 according to the embodiment also includes an issuer device 200 serving as an issuer of a data card to be described later and a verifier device 300 serving as a verifier of the data card. The issuer device 200 and the verifier device 300 may be general server devices, or may be general terminal devices similar to the terminal device 10. Furthermore, the server device 100 itself can also be the issuer device 200 or the verifier device 300.

### 2. Data Card

In the present embodiment, in order to provide useful data such as identification and behavior proof of a user exchanged between the user and a specific account in a messenger application or the like to another service, a method and a mechanism for easily and safely providing or sharing useful data in a card format between any accounts in an application (or via an application) using a concept of “a data card” will be described.

At present, there is no function of providing data exchanged between the user and a specific account in a messenger application or the like to another service. Therefore, useful data regarding the user exchanged between an individual account and another individual account (between individual accounts), between an individual account and an official account, between an individual account and an unofficial account, or between an individual account and a group account cannot be utilized between other accounts.

Note that the official account is an account of a business operator or the like that is officially recognized by a messenger application or the like or provides a transmission function thereof. The official account can communicate (including automatic response) with the user, and can provide various services in cooperation with a Web service or the like.

For example, even when personal authentication is performed using the My Number Card with an official account of a local government (○○ ward or the like) , another account that require identification confirmation may separately require presentation of an identification card. Even when the procedure is performed over time in the public personal authentication service of the local government, the user's data is available only to the service of the local government. Useful facts found as a result of using this service, such as “a resident of the local government” and “a combination of correct address and name”, cannot be used as data in the service of another account. This causes an opportunity loss of both the user and the service side.

In addition, unlike public services by the local government or the like, reliable information cannot be used in private services, and thus it is difficult to determine whether an identification card presented by a user is authentic or fake (whether the content thereof is true or false). In addition, even when the presented identification card is authentic, there is a possibility of unauthorized use in a case where the identification card is a borrowed or a stolen product. In addition, the user has to give the data while feeling resistance with the labor of photographing the identification card, the storage destination thereof, and the like not being sufficiently explained, which creates a disadvantage to both sides.

In addition, in principle, it is not possible for other business operators to know the exchange and behavior with one-to-one services including the exchange with a messenger application or the like from the viewpoint of privacy protection. Therefore, for example, even when the user makes “identification confirmation with My Number Card” according to a specified procedure, it is necessary to make a similar identification confirmation again or separately by a different means when the account with which data is exchanged is changed. This is very troublesome for the user, and the business operator often feels uneasy about the impersonation possibility and the data reliability verification and storage method.

Therefore, in the present embodiment, a mechanism for easily and safely sharing useful data in a card format (data card) between a plurality of services or accounts is introduced. For example, an exchange partner issues, as a certificate, a fact that the user has performed an action (identification confirmation or predetermined action). The certificate is created in a format that can be verified by anyone. The certificate is displayed in the form of a data card, and an issuer, a content form thereof, a valid condition, and the like can be confirmed at any time. A platform that exchanges data supports issuance, verification, presentation, and storage of the data card, and ensures authenticity and transparency of the data card.

Specifically, the user himself/herself selects and stores all data via the application including the exchange between the user and the business operator as a data card. Then, a function of verifying correctness of content by anyone using a cryptographic technology is provided, and secure data distribution between accounts of an application is supported. Note that the data card is merely a name for convenience, and may actually correspond to the data card according to the present embodiment.

For example, as illustrated in FIG. 1, the server device 100 provides a data card creation function (data card issuing function) to an issuer (here, the issuer device 200) that has received a data card creation request (data card issuing request) from the terminal device 10 of the user U (user), and creates (issues) the data card in cooperation with the issuer (Step S1). The issuer is a specific account that has exchanged data with the user. Note that the creation (issuance) of the data card may be performed independently (singly) by the issuer, or may be performed by the server device 100 as internal processing. For example, the server device 100 may create (issue) the data card on behalf of the issuer to transmit the data card to the issuer. In addition, the server device 100 itself may be the issuer. In addition, the server device 100 may provide a data card creation function (data card issuing function) in an application such as a messenger application of the terminal device 10 of the user U.

Next, the server device 100 provides the terminal device 10 of the user U with a function of managing a wallet for storing the data card, and stores the data card in the wallet in cooperation with the terminal device 10 of the user U (Step S2). In practice, the wallet may be generated in an application such as a messenger application of the terminal device 10 of the user U. In addition, the wallet itself may be an application.

The server device 100 receives an operation on the data card stored in the wallet from the terminal device 10 of the user U (Step S3). In practice, the user U may perform an operation on the data card stored in the wallet in the application of the terminal device 10.

Next, when the terminal device 10 of the user U presents the data card stored in the wallet to the verifier, the server device 100 formats and presents the data of the data card in accordance with the verifier (Step S4). In practice, the user U may format the data of the data card stored in the wallet in the application of the terminal device 10 and present the data to the verifier.

Next, the server device 100 provides the verifier (here, the verifier device 300) to whom the data card is presented with a data card verification function, and verifies the data card in cooperation with the verifier (Step S5). The verifier is another account presented with the data card by the user. Note that verification of the data card may be performed independently (singly) by the verifier, or may be performed by the server device 100 as internal processing. For example, the server device 100 may perform the verification of the data card on behalf of the verifier to return the verification result to the verifier. Furthermore, the server device 100 itself may be a verifier. In addition, the server device 100 may provide a data card verification function in an application such as a messenger application of the terminal device 10 of the user U.

Here, each processing of Steps S1 to S5 of the above server device 100 may be executed by a different server device for each processing instead of the same server device. That is, the functions may be distributed to a plurality of server devices 100. Furthermore, the processing may be executed by the terminal device 10 or the server device 100 of the user U, the issuer, or the verifier.

As a result, transparency of data distribution is technically ensured, so that use of the service can be promoted with security.

Note that the server device 100 may issue and verify the data card using artificial intelligence (AI) such as a generative pre-trained transformer (GPT). For example, the functions related to issuance, verification, presentation, and storage of the data card may be implemented by the AI such as the GPT. The GPT is a text generation AI and is a language model capable of generating a sentence using natural language processing.

### 2-1. Entity

The user is a subject of data. An issuer certifies authenticity of data and issues a data card. A verifier receives a presentation of the data card from the user, verifies the reliability of the data by an appropriate method, and provides a service according to the result. Note that, in a case where the user himself/herself inputs a data card to the AI, the AI serves as a verifier.

The platformer provides all or some of functions for the above three parties (user, issuer, verifier) to issue, verify, present, and store the data card. That is, the platformer provides a platform that issues, verifies, presents, and stores the data card. Note that the platformer may be any of the above three parties. In the present embodiment, the server device 100 functions as a platformer.

### 2-2. Issuance of Data Card

The issuance of the data card is performed by an exchange partner with whom the user has taken an action or a third party who has verified the fact. For example, an official account of a local government (○○ ward or the like), a platformer, or the like issues a data card. Note that the platformer may recreate a new data card after verifying the data card issued by a local government or the like.

In the present embodiment, a template of the content or the user interface (UI) is generated, and the user selects (a plurality of) templates. Here, the subject that generates the template has the following patterns.
Pattern 1: A template is prepared in advance by the issuer.
Pattern 2: The user applies for a formatted template in any manner, (and the issuer approves the template).
Pattern 3: A template applied by another user is shared.
Pattern 4: An AI or the like generates a template required through natural language processing or the like.

In addition, the user may create any data card, and the user himself/herself may approve the data card as an official data card. In addition, there may be an issuance option for a party to whom the data card is presented.

Specifically, in pattern 2, the approval of the content is not realistic because the content is applied for each template formatted in any manner, the confirmation of the content is very complicated, and many chances for approval are required. Therefore, the issuer determines an allowable data range (an address is up to a city, ward, town, county), a data type, and the like to reduce confirmation items of the content and chances for approval. Note that the UI can be set by the user in any manner.

As illustrated in FIG. 1, a data card DC includes an issuer IS of the card, provided data PD, and a trust mark MK of the data card. The card issuer IS is not limited to a local government or a business operator, and may be an individual. The provided data PD is automatically input to another account. Note that the data of the issuer IS, the provided data PD, and the trust mark MKcan also be delivered to another account with the data card DC as a whole. The trust mark MK of the data card indicates that the data has not been tampered with. In addition, it indicates that the expiration date has not expired. In addition, the platformer may check whether the data is valid before the provided data PD or the data card DC is transmitted, or the platformer may provide and support a means by which a receiver (verifier) verifies the authenticity of the data.

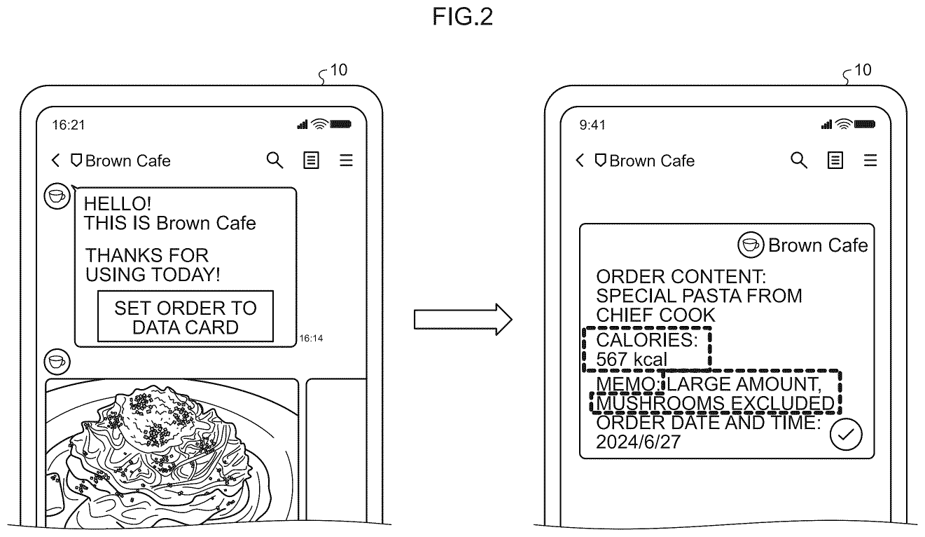

In addition, as illustrated in FIG. 2, data that is likely to be useful for the user from exchange of accounts and reservation data is used as a data card. How to use data is different for each user. FIG. 2 is an explanatory diagram illustrating a case where useful data is made to a data card.

For example, a button of “set the order to the data card” is displayed in a message from an official account of a store such as a restaurant, and when the button is pressed, data related to the order is set to the data card. In this case, the store is the issuer.

In the example illustrated in FIG. 2, an order at a store is set to a data card. The data related to the order is “order content: special pasta from the chief cook”, “calories: 567 kcal”, “memo: large amount, mushrooms excluded”, and “order date and time: 2024 Jun. 27”. For example, for the data of “calories: 567 kcal”, in a case where the user is under the meal management by the personal gym, the data is available for the purpose of “I want to transmit the data for one month to the trainer” or “I want the data to be put in the health care application”. Furthermore, regarding the data of “memo: large amount, mushrooms excluded”, the data is available for the purposes of “no problem with normal amount next time . . . ” and “I want to share that I ate with this menu with everyone on the SNS”.

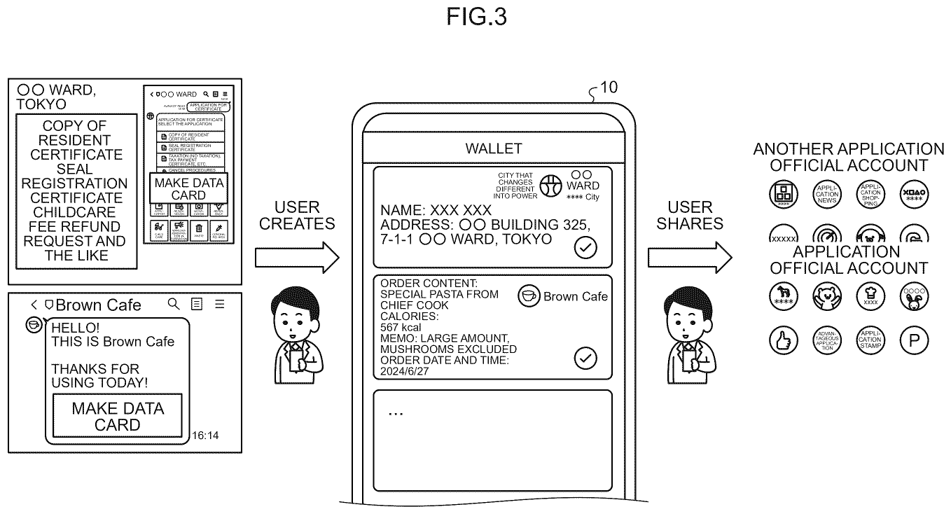

Then, as illustrated in FIG. 3, useful data is easily and safely shared by a plurality of services and accounts with the data card. FIG. 3 is an explanatory diagram illustrating an image of easily and safely sharing useful data with a data card.

For example, the user creates a data card when performing procedures such as a copy of a resident certificate, a seal registration certificate, and a childcare fee refund request in a local government “○○ ward, Tokyo”. For example, the user requests a local government “○○ ward, Tokyo” to issue a data card. The issuer of this data card is the local government “○○ ward, Tokyo”.

In addition, as illustrated in FIG. 2, a button “set the order to the data card” is displayed in a message from an official account of a store such as a restaurant, and when the button is pressed, data related to the order is set to the data card. The issuer of the data card is a store.

The wallet manages these data cards. Then, by receiving the consent of the user, the data card is shared with another account. For example, when the user presents the data card to another account, the another account can also browse the data of the data card. Note that the wallet may be an independent wallet application or a sub application accompanying a messenger application or the like.

### 2-3. Storage of Data Card

In the present embodiment, the server device 100 provides the terminal device 10 of the user U with a function of managing a wallet for storing a data card as a certificate in the user area. In practice, the server device 100 may provide the wallet management function (wallet management API) to the application of the terminal device 10 of the user U, and the application of the terminal device 10 of the user U may generate and manage the wallet using the wallet management function. As a result, the function of the wallet is added to the terminal device 10 of the user U, and the user U can operate the wallet and the data card. The user area is preferably a secure element. Note that the storage location of the data card may not be a specific wallet.

At this time, the terminal device 10 of the user U may store the raw data of the data card only in the wallet. Alternatively, the terminal device 10 of the user U may store the raw data in the wallet, and copy (duplicate) and store the same content on the cloud as a backup. Note that the terminal device 10 of the user U stores not the raw data but the encrypted data on the cloud. Furthermore, in a case where the encrypted data is stored on the cloud, the terminal device 10 of the user U may manage the data in the blockchain using a distributed ledger technology (DLT). In practice, the above processing may be executed by the server device 100 as internal processing of the application instead of the terminal device 10 of the user U.

In addition, the user can operate the data card. For example, the user can browse, delete, issue, and format the data card in any manner. The user can also format the existing data card and issue a new data card. At this time, the server device 100 firmly confirms the identity of the user by FIDO authentication or the like as necessary. In addition, in order to prevent falsification of data, a limit or a range in which the user can format data may be limited by a data formatting policy or the like (○○ ward 1-1-1→○○ ward and the like).

In addition, when the number or the capacity of the data cards increases, it is expected that it is difficult to store and manage the data cards in only the user area of the terminal device 10 of the user U. In this case, the server device 100 may classify the data card of each user for each user and unify management of the each data card. The wallet of the terminal device 10 of the user U may call up the data card of the user U from the server device 100 when using the data card.

### 2-4. Presentation of Data Card

The user may present the data card to any verifier. The user may present the data card owned by the user as it is, or may present the data after formatting the data. Note that the wallet may convert the content of the data card at the time of presentation into a two-dimensional code such as a QR code (registered trademark) in response to a user's operation or automatically. That is, the user may present the content of the data card stored in the wallet in the form of a two-dimensional code.

As an example of data formatting, partially hiding, partially blurring, putting together the data, and the like can be considered. For example, an existing technology such as selective disclosure is assumed as a means for partially hiding. In addition, as a means for partially blurring, part of data may be reduced (or simplified), for example, “○○ ward 1-1-1”→“○○ ward”. When it is a numerical value, rounding processing may be performed. In addition, as a means for grouping, a new data card C for grouping may be issued by a platformer such as “data card A (issuer: ○○ ward)+data card B (restaurant)=data card C (application)”. In this case, only the data card C is presented, and the verifier relies on the platformer in verifying the data card C. Alternatively, the verifier can verify the data card by causing the user to separately present the data card A and the data card B from the reference information. Alternatively, the disclosed attribute may be adjusted (automatically) by the depth of the relationship between the users (between accounts).

As an example of data presentation timing, the following patterns are conceivable. For example, data presentation is recommended from the platformer to a user matched by attribute matching. Alternatively, the user presents a data card of a matter that the user wants to prove. For example, it is posted on an SNS such as an open badge (OpenBadge). Alternatively, data card may be issued according to a need for data presentation (without using selective disclosure or the like).

Note that another account to whom the data cards are presented may also be a verifier. In this case, the another account verifies the data card using a verification function provided by the platformer. In practice, the another account may have a verification function by itself, and may perform verification after collecting information (for example, the public key) necessary for verification.

### 2-5. Verification of Data Card

In the verification of the data card, an electronic signature with an asymmetric key is assumed, and the retention of the secret information by the issuer is confirmed by the public information. Anyone can make a verification by the platformer providing a verification function (any account can be a verifier). Especially in the case of off-line, anyone may make a verification visually (for example, a clock is moving). Note that the verifier may have a verification function by himself/herself and make a verification after collecting information necessary for verification (for example, the public key).

The verifier may make a request of the user in advance for necessary data. The data may be matched by the platformer, but presentation of the data card is performed only based on user agreement.

### 2-6. Use of Data Card

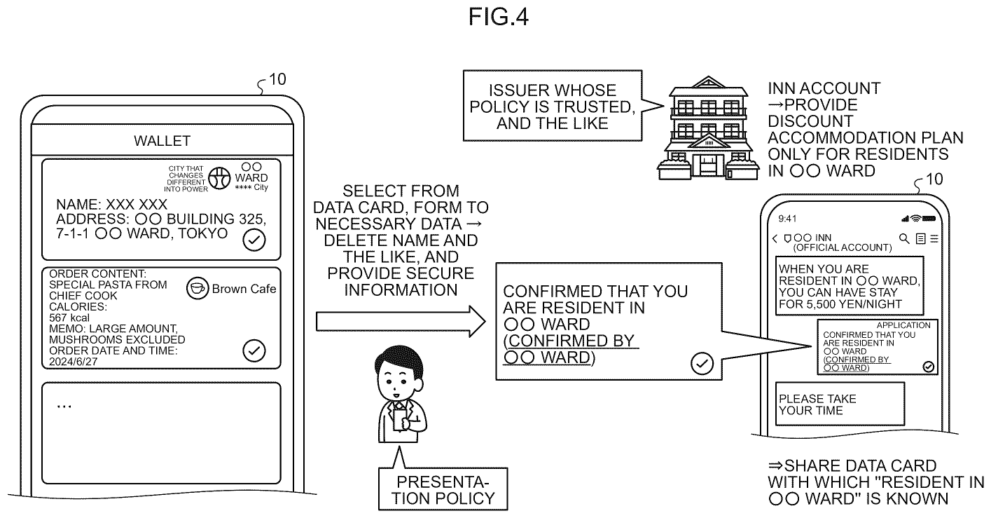

With reference to FIG. 4, for example, a case where the user uses the service using the data of “resident in ward” will be described. FIG. 4 is an explanatory diagram illustrating an image of use. For example, it is assumed that the official account of the inn provides a discount accommodation plan only for residents in ○○ ward. The user selects a data card issued from ○○ ward among data cards managed by the wallet, selects address data indicating “resident in ○○ ward” from the data card, and formats the selected address data into necessary data. For example, the name and the like are deleted, and a data card on which only safe information of “○○ ward, Tokyo” in the address is posted is presented to the official account of the inn. As a result, the wallet shares a data card indicating “resident in ○○ ward” with the official account of the inn.

The official account of the inn verifies the presented data card using a verification function of the platformer, and confirms that the user lives in the ○○ ward. At this time, the official account may confirm that the address of the user is “○○ ward” from the provided data PD, or may confirm that the issuer IS of the card is “○○ ward”.

### 2-7. Picking Up Necessary Data

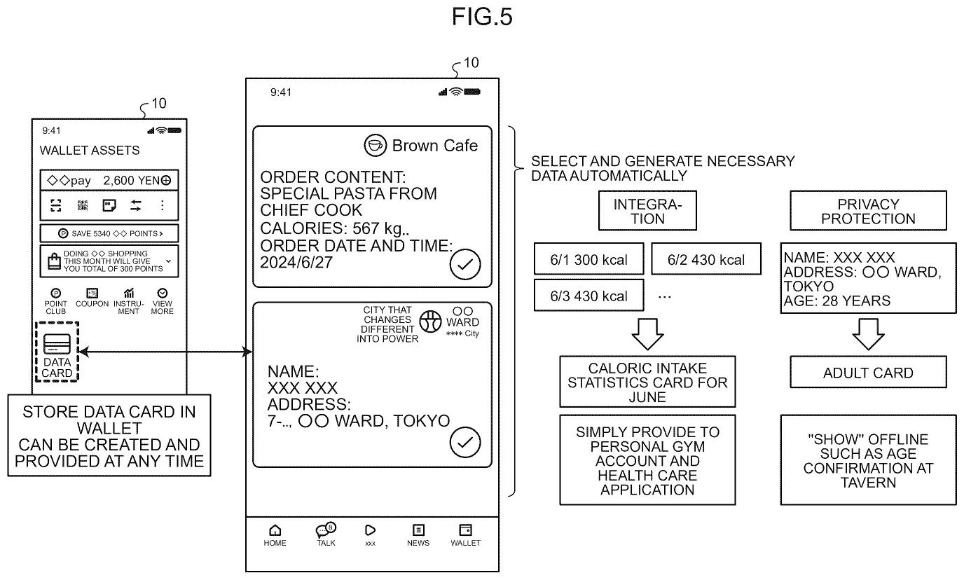

Storage of the data card and pickup of necessary data will be described with reference to FIG. 5. FIG. 5 is an explanatory diagram illustrating an image of data pickup. As illustrated in FIG. 5, the data card is stored in a wallet and can be created and provided at any time.

When presenting the data card, the wallet automatically selects necessary data from the stored data card and generates a data card for presentation. For example, the wallet collects daily data such as “6/1 300 kcal”, “6/2 430 kcal”, “6/3 430 kcal”, . . . on a monthly basis to generate a data card of “caloric intake statistics card for June”, and easily presents the data card to an account of a personal gym or a health care application.

Alternatively, the wallet generates, for privacy protection, a data card of “an adult card” that hides unnecessary data and certifies only that the user is an adult based on the data card of “name: XXX XXX”, “address: ○○ ward, Tokyo”, and “age: 28 years old”, and presents offline the data card when confirming the age at a tavern.

Note that the above processing of the wallet is performed by the terminal device 10 of the user U who uses the wallet. In practice, the above processing of the wallet may be performed by the server device 100 as the internal processing of the application.

### 2-8. Batch Use of Data Card

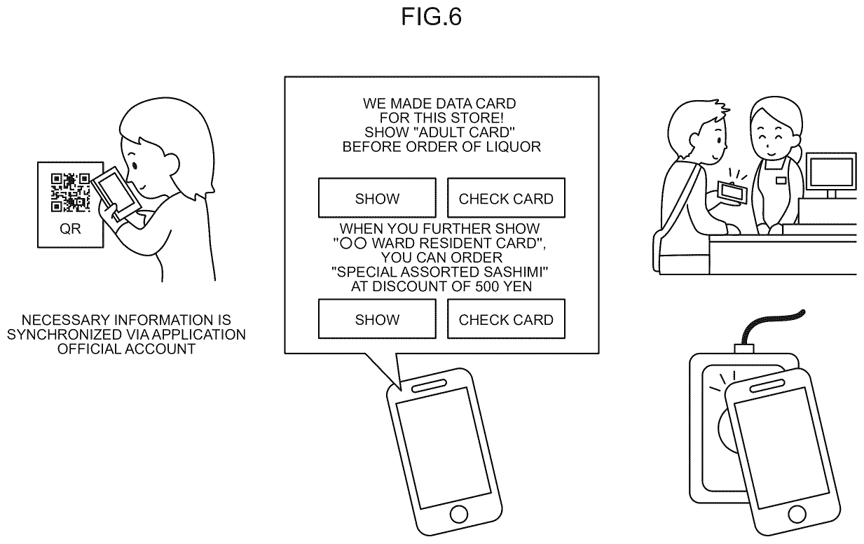

A case where data cards are collectively used in a store will be described with reference to FIG. 6. FIG. 6 is an explanatory diagram illustrating an image of batch use of data cards.

For example, in a message addressed to a user who uses a store, buttons of “show” and “confirm card” are displayed under a sentence of “The data card was made for this store! Show “the adult card” before order of liquor”. When the “show” button is pressed, the adult card is a presentation target (sharing target) to the store side. When the “confirm card” button is pressed, the content of the adult card is displayed and can be confirmed.

Furthermore, in the message addressed to the user who uses the store, following the above content, the buttons of “show” and “confirm card” are displayed under the sentence of “when you further show “the ○○ ward resident card”, you can order “the special assorted sashimi” at a discount of 500 yen”. When the “show” button is pressed, the ○○ ward resident card is a presentation target (sharing target) to the store side. When the “confirm card” button is pressed, the content of the ○○ ward resident card is displayed and can be confirmed.

### 2-9. Use Case

It is also possible to provide a new service through an account other than the official account of the local government “○○ ward, Tokyo”. For example, is provided a service that allows only residents in ○○ ward to stay at an inn in Izu at a low price. At this time, the data presented as the data card may be only “resident in ○○ ward”. The name and age are deleted or hidden because they are not desired to know.

In addition, in a case where it is desired to create a renting card with one smart phone, data indicating “a place where the user actually lives” or “a place where the user is currently in office or in school” is presented as a data card. These data are passed “simply” and “securely”.

Note that the wallet performs a process of hiding unnecessary data in response to a user operation or automatically according to a predetermined rule. For example, the wallet generates a data card indicating “a resident in ○○ ward” from the data card indicating “○○ ward 1-1-1, XXX XXX (28)” in response to a user's operation or automatically.

In addition, the wallet performs a process of grouping certain data with other data in response to an operation by the user or automatically according to a predetermined rule. For example, the wallet generates a data card indicating “resident in and working in Tokyo” from a data card indicating “○○ ward 1-1-1, XXX XXX (28)” and a data card indicating “an employee of the ○○○○ company” in response to a user's operation or automatically.

### 2-10. Distribution of Data Card

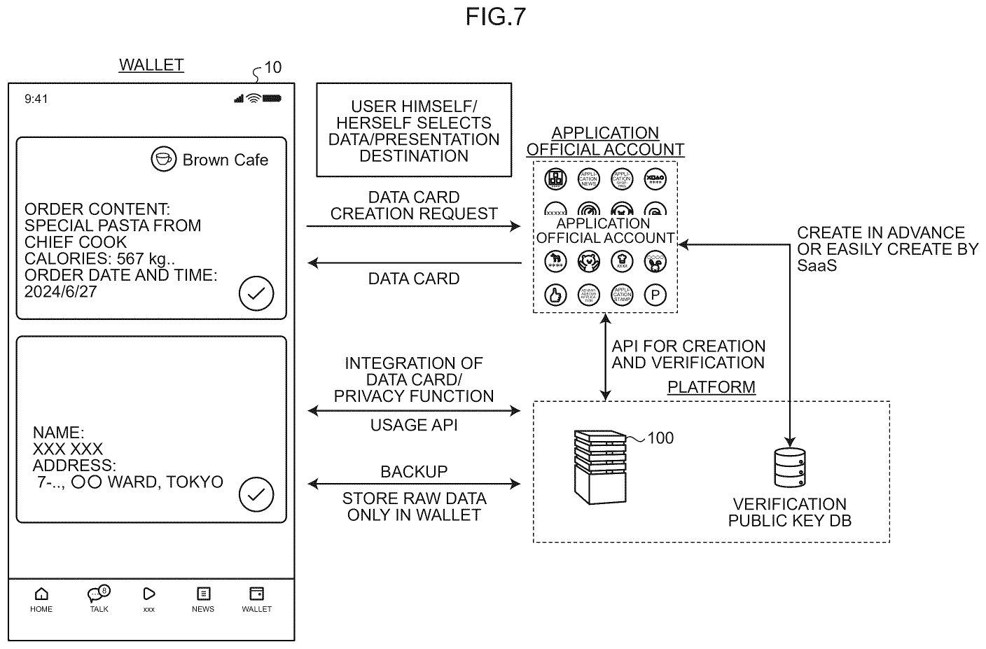

Distribution of the data card will be described with reference to FIG. 7. FIG. 7 is an explanatory diagram illustrating an image of distribution of a data card. As illustrated in FIG. 7, new data is distributed as a data card by provision of the platform. At this time, the user selects the data card and the presentation destination of the data card.

For example, a data card creation request of “set the order to the data card” is made to an official account of a store such as a restaurant. At this time, the platformer providing the platform provides the API for creating and verifying the data card to the official account of the store. The official account of the store uses the creation and verification API to set data about the order into a data card. In addition, the official account of the store registers the verification public key of the data card created in advance or simply created by SaaS in the verification public key DB. That is, the data card is a public key certificate.

In addition, when using (presenting) the data card, the wallet requests an API for integrating the data card and utilizing the privacy function from a platformer that provides the platform. That is, the wallet calls up the API for integrating the data card and utilizing the privacy function to format the data. The wallet also cooperates with a platformer providing the platform to back up the data card. The raw data of the data card is stored only in the wallet.

### 2-11. Formation of Data Card Utilization Market

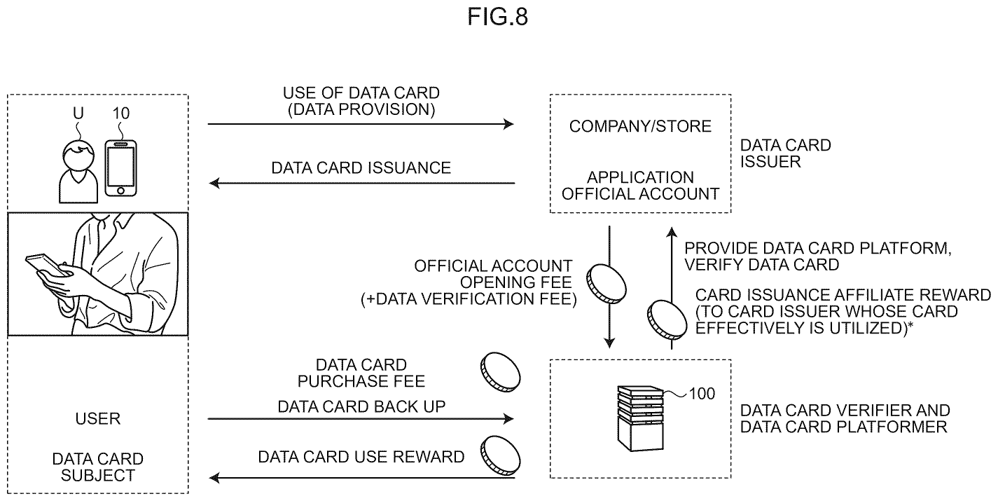

Formation of the data card utilization market will be described with reference to FIG. 8. FIG. 8 is an explanatory diagram illustrating an image of formation of a data card utilization market. For example, as illustrated in FIG. 8, an official account of a company, a store, or the like serves as a data card issuer and issues a data card to the user. In addition, the user uses the data card (provides data) for an official account of a company, a store, or the like as a data card subject.

The official account of a company, a store, or the like that is the data card issuer pays an official account opening fee (and a data card verification fee) to the server device 100 that is the data card verifier and the data card platform provider. The server device 100 provides a data card platform to an official account of a company, a store, or the like, and verifies the data card (provides a data card verification function). In addition, the server device 100 pays a data card issuance affiliate reward to the effectively used card issuer.

The user who is a data card subject pays a data card purchase fee corresponding to the number and the type of data cards (issued data cards) managed by the wallet to the server device 100 which is a data card verifier and a data card platform provider. Note that, in practice, the wallet usage fee may be paid instead of the data card purchase fee.

In addition, the user requests the server device 100 to back up the data card. The server device 100 stores the raw data of the data card only in the wallet, and stores the encrypted data on the cloud as a backup. In addition, the server device 100 pays the user a data card use reward corresponding to the used (presented) data card.

### 2-12. Template and Card Creation

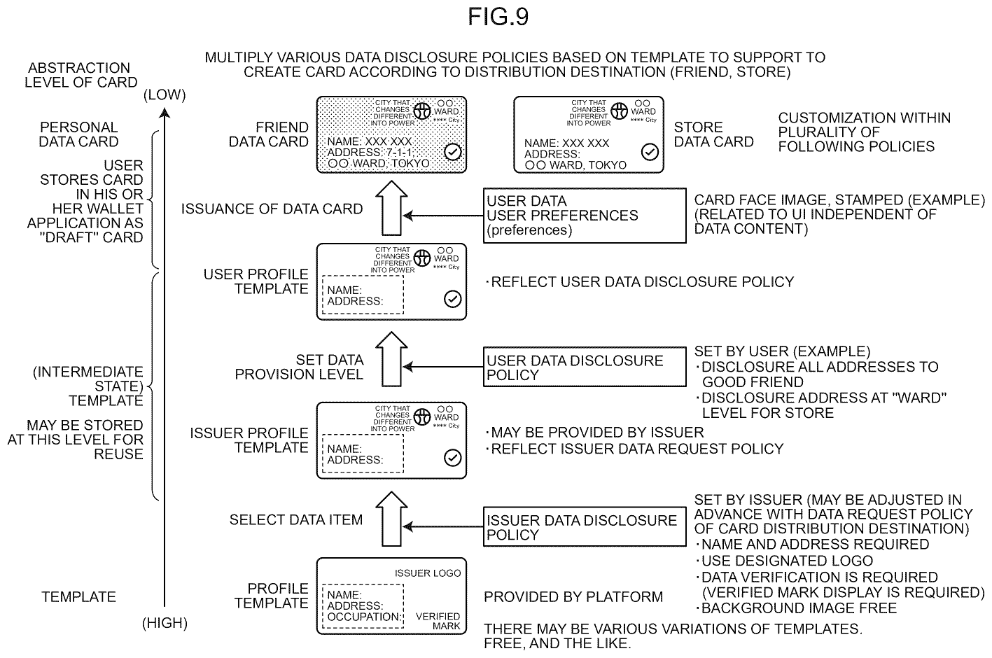

An example of template and card creation will be described with reference to FIG. 9. FIG. 9 is an explanatory diagram illustrating an image of template and card creation. For example, as illustrated in FIG. 9, the platformer multiplies various data disclosure policies based on a template to support card creation according to a distribution destination (friend, store).

As illustrated in FIG. 9, the abstraction level of the data card decreases in the order of the profile template→the issuer profile template→the user profile template→the friend data card or the store data card. That is, the profile template has the highest card abstraction level, and the friend data card or the store data card have the lowest card abstraction level.

The profile template is a basic template provided by the platform. The profile template includes an input field of a name, an address, and an occupation of the user (a region of the provided data PD of FIG. 1), and a field of an issuer logo (a region of the issuer IS of the card of FIG. 1) and a field of a verified mark (a region of the trust mark MK of FIG. 1). Note that, as the profile template, there may be templates of various variations.

The issuer profile template may be provided by the issuer. The issuer profile template is a template that reflects the issuer data disclosure policy and selects a data item from the profile template. The issuer data disclosure policy is, for example, set by the issuer (may be adjusted in advance with the data request policy of the card distribution destination), name and address are required, a specified logo is used, data verification is required (verified mark display is required), background image is free, and the like. However, the above is merely an example. Actually, the present disclosure is not limited to the above example.

The user profile template is a template reflecting the user data disclosure policy and setting the data provision level to the issuer profile template. The user data disclosure policy is, for example, set by the user (example), the address is entirely disclosed only to a good friend, the address is disclosed by the “ward” level, and the like to a store. However, the above is merely an example. Actually, the present disclosure is not limited to the above example.

The issuer profile template and the user profile template are templates in an intermediate state. The issuer profile template and the user profile template include an input field of a name and an address of the user, and a logo of “○○ ward” as an issuer logo and “trust mark” as a verified mark. The issuer profile template and the user profile template reflect the issuer data disclosure policy, and include the user's name and address, but the user's occupation is not required (essential) and thus excluded. The user may store the template in the wallet at this level (state of the issuer profile template or user profile template) for reuse of the template. In addition, the user stores “the user profile template” in the user's own wallet as “a draft” card of a friend data card or a store data card.

The friend data card or the store data card is a personal data card, and is a data card that reflects user data and user preferences and that is issued based on a user profile template. The user data and the user preferences are, for example, a data card face image (related to a UI independent of data content), a stamped (example), or the like. However, the above is merely an example. Actually, the present disclosure is not limited to the above example. In addition, the friend data card or the store data card can be customized within the scope of the plurality of policies described above.

Here, the friend data card reflects the user data and includes “name: XXX XXX” and “address: 7-1-1, ○○ ward, Tokyo”, and a logo of “○○ ward” and “trust mark”. The store data card reflects the user data and includes “name: XXX XXX” and “address: ○○ ward, Tokyo”, and a logo of “○○ ward” and “trust mark”. As compared with the friend data card, the store data card is a data card on which only safe information of “○○ ward, Tokyo”in the address is posted.

Specific use cases and templates for each level will be described below.
(1) Provision of service only for residents of the predetermined local government
Use case pattern: A discount accommodation planis provided only for residents in ○○ ward.
Issuer: ○○ ward
Verifier: Inn
Platformer: Application
Issuance: A data card is created from the template of the public personal authentication service of the ○○ ward.
Verification: The data card is verified in the application messenger (application messenger function).
Presentation: The data card is presented after the data card partially blurred (○○ ward 1-1-1→○○ ward, etc.) .
(2) Change in content of data card for each use scene
Use case pattern: The content is changed according to the relationship between the subject of the data card and the verifier.
Issuer: ○○ ward
Verifier: Inn/family
Platformer: Application
Issuance: A data card is created from the template of the public personal authentication service of the ○○ ward.
Verification: The data card is verified in the application messenger.
Presentation: The data card is presented after performing a process of partially hiding the data card (assuming an existing technology such as selective disclosure). For inns, the data card is presented after hiding information other than the address. For the family, name, gender, and address are presented.
(3) Pre-creation of data card for each use scene
Use case pattern: A plurality of data cards are created in advance according to a relationship in which the data card may be transmitted.
Issuer: ○○ ward
Verifier: Inn/family
Platformer: Application
Issuance: The plurality of data cards are created from a plurality of templates of the public personal authentication service of the ○○ ward. At the time of creation, the plurality of data cards are created after selecting three types of templates for a family, a friend, and others.
Verification: The plurality of data cards are verified in the application messenger.
Presentation: For inns, the data card for others is presented. For the family, the data card for the family is presented.
(4) Issuance of group card
Use case pattern: A group card (a data card in units of groups) is created in a user group having a predetermined relationship such as a family member or a friend.
Issuer: Store/Restaurant (place to eat and drink or the like)
Verifier: Application provider
Platformer: Application provider (performing account management on behalf of issuer)
Issuance: It is assumed that the host user (the user who is the organizer) makes a reservation to have a meal at the restaurant (with an official account) in a group. For example, an account (or a uniquely identifiable identifier) of a participant user (the user who is the participant) is registered in an application. At the timing of having a meal at the restaurant, the host user issues (requests the issuer to issue) a group cardthat certifies having had the meal in the group (preserves a photograph of the participants) in commemoration of having had the meal in the group. At this time, the above photograph is uploaded and the group card is immediately issued using the issuer profile template for the store. The participant user is added as a friend in the official account if not yet, immediately downloads the above issued group card, and saves the group card in the user's own application (wallet).
Verification: a group user (a user belonging to the group: a host user or a participant user) is granted a point by presenting the above group card when the group user visits the restaurant. Alternatively, when the group user visits the restaurant again next time, the group user can get a discount by presenting the above group card.
Presentation: The group card is presented at a restaurant. As in the personal card (group card for each user), the group card is associated with the official account of the restaurant and can also be integrated in the personal card. For example, since the group card at the restaurant proves that the group has had a meal together, based on this information, the personal card may incorporate information of “having had a meal (having visited) at the restaurant (in the group)”. That is, the data cards in the group and the data cards in the individual can be integrated (organized).
(5) Issuance of membership card of fitness club
Use case pattern: A data card available as a fitness club membership card is created. At the presentation timing of the user, information of the data card with a high grade is suggested to the user according to the number of use of the data card.
Issuer: Fitness club
Verifier: Fitness club
Platformer: Application
Issuance: Fitness club issues “a membership data card” to members thereof.
Verification: The membership data card is verified in application messenger, fitness club checks the membership card in the application messenger to check “how many times this member is using”.
Presentation: When the usual membership card is presented by the application, the data card of the next step is suggested according to the use frequency. For example, a motivation-up message such as “issuance of a gold membership data card is possible with three more uses” is also included.
(6) When school discount is used for movie (use internship certificate card)
Use case: Temporary authentication is performed with another data card (a data card issued by another issuer), which is currently not target data card, and the target data card is submitted later.
Presentation: A student attempts to use a student discount at a movie theater, but finds that there is no student certificate data card. For example, it is useful in a situation where “Sorry, I do not have a student certificate data card, but I will present an internship certificate card through the application instead”. In addition, the platform suggests a usable data card instead of the student certificate data card.
Issuer: Internship company
Verifier: Movie theater
Platformer: Application
Issuance: The Internship company issues the internship certificate card of the student.
Verification: The movie theater side checks the internship certificate card in the application messenger and checks “whether this student can use a student discount?”. The movie theater side informs the student that “submit the student certificate data card later (within a predetermined period of time)”. At a later date, the student submits a formal student certificate data card, and when there is no problem, the temporary use is officially approved.

### 2-13. Effect of Data Card

In the present embodiment, by using the platform that issues, verifies, presents, and stores the data card, the user can perform data distribution and secondary use on the user's own behalf while controlling the user's own data. In addition, privacy can be protected. In addition, a data card customized according to a destination can be transmitted. In addition, the verifier can easily receive correct data. In addition, the issuer does not need to make the same attestation many times. Further, platform engagement may be improved.

In addition, by using a data card as a certificate, a certificate issuing system that allows a user to control actions on a service on the user's own behalf is implemented.

In addition, a cycle of generating new data from the service, such as “use service”→“create data card”→“store data card”→“integrate data card”→“use/show data card”→“use service” . . . (repetition), is generated.

The user can also use the user's own favorite data as a data card or automatically create the data card with reference to a predetermined rule or a data card created by another user.

There are hundreds to thousands of data. The wallet automatically select an appropriate data card depending on the party to be presented, and can use the selected card when the user agrees (permits) the card.

The data card is a means that saves time and effort for input and proof and safely notifies the other party that the data thereof is the user's own data. Since the information is reliable information, communication that maximizes the life time value (LTV) can be promoted.

### 2-14. Additional Function

A type of the data card is set, and a premium card is prepared. For example, the more frequently the data card is presented, more valuable the card is. A mechanism such that the user wants to present the card many times such as use of a black card is implemented. In addition, by possessing the premium card, the degree of reliability of the user may be evaluated.

In addition, a function of changing the design (picture) of the data card displayed on the screen (so-called changing of clothes) may be provided.

In addition, the score may be set for each card. For example, in a case where a result of determining whether the user is a heavy eater by exchanging a message or the like is represented by a score, the score of the user as a heavy eater is represented by “0” to “0.5” to “1”, and uneven determination can be made via a data card. Scores can also be used for the service, such as “providing special menus with 0.7 or more”.

In addition, when the group card is generated for each predetermined user group, the users in the group may give a seal of approval to each other. In addition, the seal of approval may be given to the user group from the store. For example, a couple of users can create “(or a store can create for the couple)” a group card that serves as a certificate indicating that “the two had a meal at the XYZ restaurant together on ○ (month), ○ (day)”. In addition, the presence of a plurality of users in the group may be collectively proved by the group card.

### 2-15. Other Viewpoints

From other viewpoints, in the present embodiment, a system for automatically creating a user certificate based on a policy is implemented. For example, when the server device 100 receives approval by a predetermined approval organization regarding the user information input by the user, the server device 100 registers information indicating that the user information has been approved in association with the user information. Next, when the server device 100 receives a confirmation condition (policy) from the requester who requests the confirmation of the user information, the server device 100 determines whether there is the user information matching the policy. Then, the server device 100 provides the requester with information corresponding to the determination result. Examples of the confirmation condition (policy) include user information, approver information, organization, and the like.

### 3. Configuration Example of Terminal Device

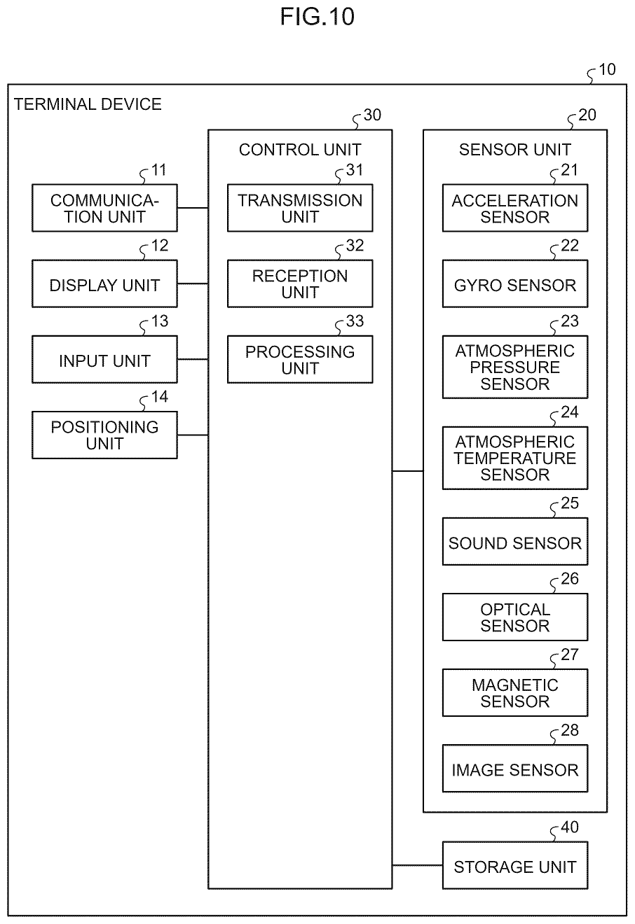

Next, a configuration of the terminal device 10 will be described with reference to FIG. 10. FIG. 10 is a diagram illustrating a configuration example of the terminal device 10 according to the embodiment. As illustrated in FIG. 10, the terminal device 10 includes a communication unit 11, a display unit 12, an input unit 13, a positioning unit 14, a sensor unit 20, a control unit 30 (controller), and a storage unit 40.

### Communication Unit 11

The communication unit 11 is connected to the network N in a wired or wireless manner to transmit and receives information to and from the server device 100 via the network N. For example, the communication unit 11 is implemented by a network interface card (NIC), an antenna, or the like.

### Display Unit 12

The display unit 12 is a display device that displays various types of information such as position information. For example, the display unit 12 is a liquid crystal display (LCD) or an organic electro-luminescent display (organic EL display). In addition, the display unit 12 is a touch panel display, but is not limited thereto.

### Input Unit 13

The input unit 13 is an input device that receives various operations from the user U. For example, the input unit 13 includes a button or the like for inputting characters, numbers, and the like. Note that the input unit 13 may be an input/output port (I/O port), a Universal Serial Bus (USB) port, or the like. Furthermore, in a case where the display unit 12 is a touch panel display, part of the display unit 12 functions as the input unit 13. Furthermore, the input unit 13 may be a microphone or the like that receives voice input from the user U. The microphone may be wireless.

### Positioning Unit 14

The positioning unit 14 receives a signal (radio wave) transmitted from a satellite of a global positioning system (GPS), and acquires position information (for example, latitude and longitude) indicating the current position of the terminal device 10 including the positioning unit based on the received signal. That is, the positioning unit 14 measures the position of the terminal device 10. Note that the GPS is merely an example of a global navigation satellite system (GNSS).

Furthermore, the positioning unit 14 can measure the position by various methods other than the GPS. For example, as auxiliary positioning means for position correction and the like, the positioning unit 14 may measure the position using various communication functions of the terminal device 10 as follows.

### Wi-Fi Positioning

For example, the positioning unit 14 measures the position of the terminal device 10 using a Wi-Fi (registered trademark) communication function of the terminal device 10 or a communication network provided in each communication company. Specifically, the positioning unit 14 measures the position of the terminal device 10 by performing Wi-Fi communication or the like and measuring the distance to a nearby base station or access point.

### Beacon Positioning

Furthermore, the positioning unit 14 may measure the position using a Bluetooth (registered trademark) function of the terminal device 10. For example, the positioning unit 14 measures the position of the terminal device 10 by connecting to a beacon transmitter connected by a Bluetooth (registered trademark) function.

### Geomagnetic Positioning

Furthermore, the positioning unit 14 measures the position of the terminal device 10 based on a geomagnetic pattern of a structure measured in advance and a geomagnetic sensor included in the terminal device 10.

### RFID Positioning

Furthermore, for example, in a case where the terminal device 10 has a function of a radio frequency identification (RFID) tag equivalent to a contactless IC card used at a station ticket gate, a store, or the like, or has a function of reading the RFID tag, a used position is recorded together with information about payment or the like made by the terminal device 10. The positioning unit 14 may measure the position of the terminal device 10 by acquiring such information. Furthermore, the position may be measured by an optical sensor, an infrared sensor, or the like included in the terminal device 10.

The positioning unit 14 may measure the position of the terminal device 10 using one or a combination of the positioning means described above as necessary.

### Sensor Unit 20

The sensor unit 20 includes various sensors mounted on or connected to the terminal device 10. Note that the connection may be a wired connection or a wireless connection. For example, the sensors may be a detection device other than the terminal device 10, such as a wearable device or a wireless device. In the example illustrated in FIG. 10, the sensor unit 20 includes an acceleration sensor 21, a gyro sensor 22, an atmospheric pressure sensor 23, an atmospheric temperature sensor 24, a sound sensor 25, an optical sensor 26, a magnetic sensor 27, and an image sensor (camera) 28.

Note that each of the sensors 21 to 28 described above is merely an example and is not limited. That is, the sensor unit 20 may be configured to include some of the sensors 21 to 28, or may include other sensors such as a humidity sensor in addition to or instead of the sensors 21 to 28.

The acceleration sensor 21 is, for example, a three-axis acceleration sensor, and detects physical movement of the terminal device 10 such as a moving direction, speed, and acceleration of the terminal device 10. The gyro sensor 22 detects physical movement of the terminal device 10 such as inclination in three axis directions based on angular velocity or the like of the terminal device 10. The atmospheric pressure sensor 23 detects, for example, the atmospheric pressure around the terminal device 10.

Since the terminal device 10 includes the acceleration sensor 21, the gyro sensor 22, the atmospheric pressure sensor 23, and the like described above, the position of the terminal device 10 can be measured using a technique such as pedestrian dead reckoning (PDR) using each of these sensors 21 to 23 and the like. This makes it possible to acquire indoor position information that is difficult to acquire by a positioning system such as a GPS.

For example, the number of steps, walking speed, and walking distance can be calculated by a pedometer using the acceleration sensor 21. In addition, it is possible to know the traveling direction, the direction of the line of sight, and the inclination of the body of the user U using the gyro sensor 22. In addition, the altitude at which the terminal device 10 of the user U exists and the floor number can be known from the air pressure detected by the atmospheric pressure sensor 23.

The atmospheric temperature sensor 24 detects, for example, an atmospheric temperature around the terminal device 10. The sound sensor 25 detects, for example, a sound around the terminal device 10. The optical sensor 26 detects illuminance around the terminal device 10. The magnetic sensor 27 detects, for example, geomagnetism around the terminal device 10. The image sensor 28 captures an image around the terminal device 10.

The atmospheric pressure sensor 23, the atmospheric temperature sensor 24, the sound sensor 25, the optical sensor 26, and the image sensor 28 described above can detect the atmospheric pressure, the atmospheric temperature, the sound, and the illuminance and capture an image of the surroundings to detect the environment, the situation, and the like around the terminal device 10 by. Furthermore, the accuracy of the position information of the terminal device 10 can be improved from the environment, situation, and the like around the terminal device 10.

### Control Unit 30

The control unit 30 includes, for example, a microcomputer including a central processing unit (CPU) or a micro processing unit (MPU), a read only memory (ROM), a random access memory (RAM), an input/output port, and the like, and various circuits. Furthermore, the control unit 30 may include, for example, hardware such as an integrated circuit such as an application specific integrated circuit (ASIC) or a field programmable gate array (FPGA). The control unit 30 includes a transmission unit 31, a reception unit 32, and a processing unit 33.

### Transmission Unit 31

The transmission unit 31 can transmit, for example, various types of information input by the user U using the input unit 13, various types of information detected by the sensors 21 to 28 mounted on or connected to the terminal device 10, position information of the terminal device 10 measured by the positioning unit 14, and the like to the server device 100 via the communication unit 11.

### Reception Unit 32

The reception unit 32 can receive various types of information provided from the server device 100 and requests for the various types of information from the server device 100 via the communication unit 11.

### Processing Unit 33

The processing unit 33 controls the entire terminal device 10 including the display unit 12 and the like. For example, the processing unit 33 can output various types of information transmitted by the transmission unit 31 and various types of information from the server device 100 received by the reception unit 32 to the display unit 12 to display them.

In addition, the processing unit 33 receives a data card via the communication unit 11 (reception unit 32) from an issuer who has issued the data card that allows another account to use the data related to a user of an account, and then stores the data card in the wallet.

In addition, the processing unit 33 receives an operation on the data card stored in the wallet via the input unit 13 from the user, and then formats data of the data card.

In addition, the processing unit 33 presents (transmits or displays) the data card to another account to be a verifier of the data card via a presentation unit (output unit) such as the communication unit 11 (transmission unit 31) or the display unit 12 according to an operation on the wallet by the user.

### Storage Unit 40

The storage unit 40 is implemented by, for example, a semiconductor memory element such as a random access memory (RAM) or a flash memory, or a storage device such as a hard disk drive (HDD), a solid state drive (SSD), or an optical disc. The storage unit 40 stores various programs, various pieces of data, and the like.

### 4. Configuration Example of Server Device

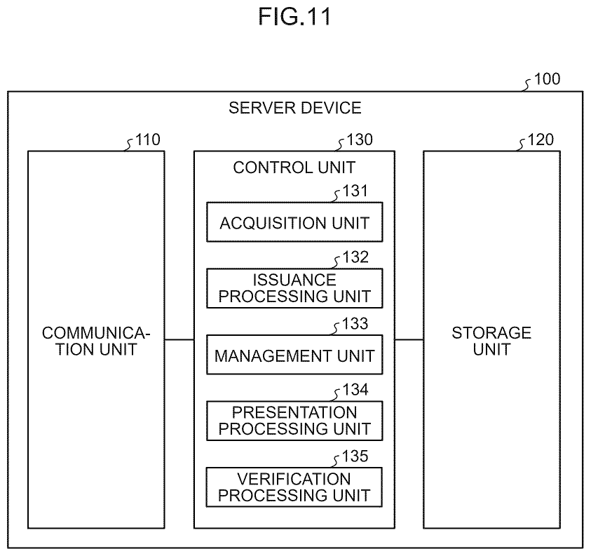

Next, a configuration of the server device 100 according to the embodiment will be described with reference to FIG. 11. FIG. 11 is a diagram illustrating a configuration example of the server device 100 according to the embodiment. As illustrated in FIG. 11, the server device 100 includes a communication unit 110, a storage unit 120, and a control unit 130.

### Communication Unit 110

The communication unit 110 is implemented by, for example, a network interface card (NIC) or the like. Furthermore, the communication unit 110 is connected to the network N in a wired or wireless manner.

### Storage Unit 120

The storage unit 120 is implemented by, for example, a semiconductor memory element such as a random access memory (RAM) or a flash memory, or a storage device such as an HDD, an SSD, or an optical disk. The storage unit 120 may store attribute information and history information (log data) of the user U together with identification information (user ID and the like) indicating the user U.

### Control Unit 130

The control unit 130 is a controller, and is implemented by, for example, a central processing unit (CPU), a micro processing unit (MPU), a graphics processing unit (GPU), an application specific integrated circuit (ASIC), a field programmable gate array (FPGA), or the like executing various programs (corresponding to an example of an information processing program) stored in a storage device inside the server device 100 using a storage area such as a RAM as a work area. In the example illustrated in FIG. 11, the control unit 130 includes an acquisition unit 131, an issuance processing unit 132, a management unit 133, a presentation processing unit 134, and a verification processing unit 135.

### Acquisition Unit 131

The acquisition unit 131 acquires a search query input by the user U (user). For example, when the user U inputs a search query to a search engine or the like and performs keyword search, the acquisition unit 131 acquires the search query via the communication unit 110. That is, the acquisition unit 131 acquires the keyword input to the search window of the search engine, the site, or the application by the user U via the communication unit 110.

In addition, the acquisition unit 131 acquires user information about the user U via the communication unit 110. For example, the acquisition unit 131 acquires identification information (user ID or the like) indicating the user U, position information about the user U, attribute information about the user U, and the like from the terminal device 10 of the user U. In addition, the acquisition unit 131 may acquire identification information indicating the user U, attribute information about the user U, and the like at the time of user registration of the user U. Then, the acquisition unit 131 stores the user information in the storage unit 120.

In addition, the acquisition unit 131 acquires various types of history information (log data) indicating the behavior of the user U via the communication unit 110. For example, the acquisition unit 131 acquires various types of history information indicating the behavior of the user U from the terminal device 10 of the user U or from various servers or the like based on the user ID or the like. Then, the acquisition unit 131 stores various types of history information in the storage unit 120.

### Issuance Processing Unit 132

The issuance processing unit 132 provides a function of issuing a data card that allows another account to use the data related to a user of an account, to the account to be an issuer of the data card. For example, the issuance processing unit 132 provides a function of issuing a data card to the account.

Furthermore, in a case where an account of a public institution such as a local government issues a data card, the issuance processing unit 132 provides a function of issuing a data card including an issuer, data indicating a name and an address of the user, and a trust mark.

In addition, the issuance processing unit 132 issues the data card using any of a plurality of templates according to a stage of the abstraction level of the data card.

In addition, the issuance processing unit 132 provides a function of issuing a data card as a group card shared by a plurality of users belonging to the same group, to an account of a store such as a restaurant.

### Management Unit 133

The management unit 133 provides the user with a function of managing a wallet that stores the issued data card. The management unit 133 stores the raw data of the data card in the wallet. In addition, the management unit 133 further stores the encrypted data of the data card on the cloud.

In addition, the management unit 133 receives an operation on the data card stored in the wallet from the user, and performs any of browsing, deleting, issuing, and data formatting of the data card according to the operation by the user.

### Presentation Processing Unit 134

When the user presents the data card stored in the wallet to the verifier, the presentation processing unit 134 formats and presents the data of the data card in accordance with the verifier. At this time, the presentation processing unit 134 provides a function of formatting and presenting the data of the data card in accordance with the verifier as a function of the wallet.

For example, when the presentation processing unit 134 formats the data, the presentation processing unit 134 partially hides, partially blurs, or integrates the data.

### Verification Processing Unit 135

The verification processing unit 135 provides a function of verifying the data card to another account to be presented with the data card by the user and to be a verifier of the data card.

In addition, the verification processing unit 135 provides a function of performing temporary authentication with another data card that is not a data card to be originally targeted, and verifying the target data card later to another account to be a verifier of the data card.

### 5. Processing Procedure

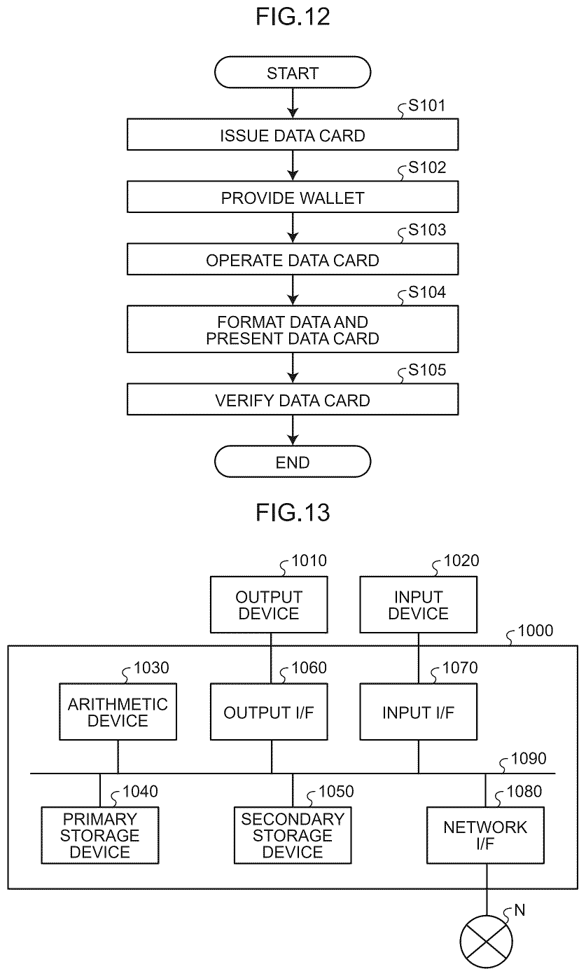

Next, a processing procedure by the server device 100 according to the embodiment will be described with reference to FIG. 12. FIG. 12 is a flowchart illustrating a processing procedure according to the embodiment. Note that the following processing procedure is repeatedly executed by the control unit 130 of the server device 100.

For example, as illustrated in FIG. 12, the issuance processing unit 132 of the server device 100 provides a function of issuing a data card that allows another account to use the data related to a user of an application official account of a local government, a restaurant, or the like, to the account to be an issuer of the data card (Step S101).

Subsequently, the management unit 133 of the server device 100 provides the terminal device 10 of the user with a function of managing a wallet that stores the issued data card (Step S102).

Subsequently, the management unit 133 of the server device 100 receives an operation on the data card stored in the wallet from the user, and performs any of browsing, deleting, issuing, and data formatting of the data card according to the operation by the user (Step S103).

Subsequently, when the user presents the data card stored in the wallet to the verifier, the presentation processing unit 134 of the server device 100 formats and presents the data of the data card in accordance with the verifier (Step S104). For example, the presentation processing unit 134 partially hides, partially blurs, or integrates the data of the data card.

Subsequently, the verification processing unit 135 of the server device 100 provides a function of verifying the data card to another account to be presented with the data card by the user and to be a verifier of the data card (Step S105).

### 6. Modifications

The terminal device 10 and the server device 100 described above may be implemented in various different modes other than the above embodiments. Therefore, modifications of the embodiment will be described below.

In the above embodiment, part or all of the processing executed by the server device 100 may actually be executed by the terminal device 10 (or an application operating on the terminal device 10). For example, the stand-alone terminal device 10 may complete the processing on a standalone basis. In this case, it is assumed that the terminal device 10 has the function of the server device 100 in the above embodiment. In addition, in the above embodiment, since the terminal device 10 cooperates with the server device 100, it seems that the terminal device 10 also executes processing by the server device 100 from the viewpoint of the user U. That is, from another point of view, it can be said that the terminal device 10 includes the server device 100.

In the above embodiment, the server device 100 may prepare the template for each store or each industry type. For example, a restaurant and a fitness gym may require different user data.

In the above embodiment, an official account of a local government may serve as an issuer to issue a data card corresponding to a copy of a resident certificate or a seal registration certificate. In addition, an official account of the National Tax Service may serve as an issuer to issue a data card corresponding to a tax payment certificate.

Furthermore, in the above embodiment, an official account of a public institution such as a school, a hospital, or a transportation system may serve as an issuer to issue a data card. For example, an official account of a school may issue a data card corresponding to a student certificate, a certificate of enrollment, or a certificate of achievement, or may issue a data card certifying a role, a position, or a record in a committee activity or a club activity (club activity or circle activity). In addition, an official account of a hospital may issue a data card corresponding to a clinic ID card, or may issue a data card integrating medical information about a patient and a medical examinee such as a medical examination history and a medical history. In addition, the official account of the transportation system may issue a data card corresponding to a reservation ticket or a commutation ticket. At this time, the server device 100 may limit a partner (presentation destination) to whom the above data card may be presented as a function of the wallet. For example, the server device 100 may present the data card only in a case where there is a presentation request of the above data card from an official account of a public institution and the user agrees to the presentation.

In the above embodiment, an official account of a company, an organization, a corporation, another business operator, an employer, or the like may serve as an issuer to issue a data card of the employee. For example, an official account of a company may issue a data card corresponding to an employee ID card or an enrollment certificate, or may create a data card including data related to skills and achievements of the employee.

Also, in the above embodiments, an official account of the qualification authority may serve as an issuer to issue a data card that can also be used as a qualification certificate. In addition, an official account of an organization that conducts a certification examination may issue a data card that certifies pass/fail or a score of the certification examination.

In the above embodiment, the server device 100 may create a data card corresponding to a resume or a job resume by collecting necessary data from the user's data card as a function of the wallet. For example, the server device 100 may create a data card corresponding to a resume or a job resume by collecting data cards issued by an official account of a school, a company, or the like in which the user is enrolled.

In the above embodiment, an official account of a travel agency or an accommodation facility may serve as an issuer to issue a data card including data related to reservation of travel or accommodation.

In the above embodiment, an official account of a financial institution such as a bank or a securities company may serve as an issuer to issue a data card including data related to financial assets owned by the user. In addition, an official account of a real estate company or a legal department may serve as an issuer to issue a data card including data regarding the real estate owned by the user. In addition, an official account of the rental management company may serve as an issuer to issue a data card including data related to the monthly rent (rent fee) paid by the user. At this time, the data of the data card includes information indicating a confirmation date or an issuance date when the issuer has checked the content of the data.

Furthermore, in the above-described embodiment, the server device 100 may automatically update or reissue the data card periodically or every time the content of the user's data changes in cooperation with the official account of the issuer as a function of the wallet.

In the above embodiment, the server device 100 may set an expiration date (or a storage period) for the data card stored in the wallet, and automatically discard and dump the data card whose expiration date has passed. In addition, the issuer of the data card may set the expiration date of the data card.

Furthermore, in the above embodiment, not only the data card of the user himself/herself but also a data card related to an article owned by the user may be issued. For example, a data card may be issued that certifies that the vendor of the user-owned article is an authorized product. In addition, a data card (with a trust mark) indicating authenticity determination and an appraisal result performed by a reliable institution may be issued.

### 7. Effects

As described above, the information processing device (the terminal device 10 and the server device 100) according to the present application includes the issuance processing unit 132 that provides the function of issuing the data card that allows another account to use the data related to a user of an account, to the account to be an issuer of the data card, the management unit 133 that provides the user with the function of managing the wallet that stores the issued data card, and the verification processing unit 135 that provides the function of verifying the data card to account to be presented with the data card by the user and to be a verifier of the data card.

This allows the user's data to be shared between accounts on the data card.

Furthermore, the information processing device according to the present application further includes the presentation processing unit 134 that formats and presents the data of the data card in accordance with a verifier when the user presents the data card stored in the wallet to the verifier.

As a result, the content of the data of the data card presented for each verifier can be changed.

When the presentation processing unit 134 formats the data, the presentation processing unit 134 partially hides, partially blurs, or integrates the data.

As a result, part of the data of the data card can be disclosed or hidden according to the verifier.

The management unit 133 receives an operation on the data card stored in the wallet from the user, and performs any of browsing, deleting, issuing, and data formatting of the data card according to the operation by the user.

As a result, the user can operate the issued data card.

The management unit 133 stores the raw data of the data card in the wallet.

Thereby, the raw data of the data card can be stored in the terminal device of the user.

The management unit 133 further stores the encrypted data of the data card on the cloud.

As a result, the backup data of the data card can be stored on the cloud.

When an account of a public institution includeing a local government issues a data card, the issuance processing unit 132 provides a function of issuing a data card including an issuer, data indicating a name and an address of a user, and a trust mark.

As a result, it is possible to issue a data card including a name and an address of the user guaranteed by a reliable institution.

The issuance processing unit 132 issues the data card using any of a plurality of templates according to a stage of the abstraction level of the data card.

As a result, for reuse, it is possible to support to create the card according to a distribution destination (friend, store) by saving the card at any template stage and multiplying various data disclosure policies based on the template.

The issuance processing unit 132 provides a function of issuing a data card as a group card shared by a plurality of users belonging to the same group to an account of a store such as a restaurant.

This makes it possible to manage the action history for each group. In addition, it is possible to receive a service for each group.

The verification processing unit 135 provides a function of performing temporary authentication with another data card that is not a data card to be originally targeted, and verifying the target data card later to another account to be a verifier of the data card.

As a result, even in a state where there is no necessary data card at hand, another data card can be temporarily substituted.

In another point of view, the information processing device (terminal device 10) according to the present application includes the processing unit 33 that receives a data card from an issuer who has issued the data card that allows another account to use the data related to a user of an account, and stores the data card in a wallet, and a presentation unit (communication unit 11 or display unit 12) that presents the data card to another account to be a verifier of the data card by an operation performed on the wallet by the user.

As a result, the data card can be managed on the terminal device of the user, and the data card can be presented to the verifier by the operation by the user.

The processing unit 33 receives an operation on the data card stored in the wallet from the user and formats data.

This allows the user to format the data of the data card in any manner.

With any or a combination of the above-described processes, the information processing device according to the present application can share user data with the data card between accounts.

### 8. Hardware Configuration

Furthermore, the terminal device 10 and the server device 100 according to the above-described embodiment are implemented by, for example, a computer 1000 having a configuration as illustrated in FIG. 13. Hereinafter, the server device 100 will be described as an example. FIG. 13 is a diagram illustrating an example of a hardware configuration. The computer 1000 is connected to an output device 1010 and an input device 1020, and has a form in which an arithmetic device 1030, a primary storage device 1040, a secondary storage device 1050, an output interface (I/F) 1060, an input I/F 1070, and a network I/F 1080 are connected by a bus 1090.

The arithmetic device 1030 operates based on a program stored in the primary storage device 1040 or the secondary storage device 1050, a program read from the input device 1020, or the like, and executes various processes. The arithmetic device 1030 is implemented by, for example, a central processing unit (CPU), a micro processing unit (MPU), a graphics processing unit (GPU), an application specific integrated circuit (ASIC), a field programmable gate array (FPGA), or the like.

The primary storage device 1040 is a memory device such as a random access memory (RAM) that temporarily stores data used for various arithmetic operations by the arithmetic device 1030. The secondary storage device 1050 is a storage device in which data used for various arithmetic operations by the arithmetic device 1030 and various databases are registered, and is implemented by a read only memory (ROM), a hard disk drive (HDD), a solid state drive (SSD), a flash memory, or the like. The secondary storage device 1050 may be a built-in storage or an external storage. Further, the secondary storage device 1050 may be a removable storage medium such as a Universal Serial Bus (USB) memory or a secure digital (SD) memory card. The secondary storage device 1050 may be a cloud storage (online storage), a network attached storage (NAS), a file server, or the like.

The output I/F 1060 is an interface for transmitting information to be output to the output device 1010 that outputs various types of information such as a display, a projector, and a printer, and is implemented by, for example, a connector of a standard such as a Universal Serial Bus (USB), a Digital Visual Interface (DVI), or a High Definition Multimedia Interface (HDMI) (registered trademark). Furthermore, the input I/F 1070 is an interface for receiving information from various input devices 1020 such as a mouse, a keyboard, a keypad, a button, a scanner, and the like, and is implemented by, for example, a USB or the like.

In addition, the output I/F 1060 and the input I/F 1070 may be wirelessly connected to the output device 1010 and the input device 1020, respectively. That is, the output device 1010 and the input device 1020 may be wireless devices.

Furthermore, the output device 1010 and the input device 1020 may be integrated like a touch panel. In this case, the output I/F 1060 and the input I/F 1070 may also be integrated as the input/output I/F.

Note that the input device 1020 may be, for example, a device that reads information from an optical recording medium such as a compact disc (CD), a digital versatile disc (DVD), or a phase change rewritable disk (PD), a magneto-optical recording medium such as a magneto-optical disk (MO), a tape medium, a magnetic recording medium, a semiconductor memory, or the like.

The network I/F 1080 receives data from another device via the network N to transmit the data to the arithmetic device 1030, and transmits data generated by the arithmetic device 1030 to another device via the network N.

The arithmetic device 1030 controls the output device 1010 and the input device 1020 via the output I/F 1060 and the input I/F 1070. For example, the arithmetic device 1030 loads a program from the input device 1020 or the secondary storage device 1050 onto the primary storage device 1040, and executes the loaded program.

For example, in a case where the computer 1000 functions as the server device 100, the arithmetic device 1030 of the computer 1000 realizes the function of the control unit 130 by executing a program loaded on the primary storage device 1040. In addition, the arithmetic device 1030 of the computer 1000 may load a program acquired from another device via the network I/F 1080 onto the primary storage device 1040 and execute the loaded program. Furthermore, the arithmetic device 1030 of the computer 1000 may cooperate with another device via the network I/F 1080, and may call a function of the program, data, and the like from another program of another device to use.

### 9. Others

Although the embodiments of the present application have been described above, the present invention is not limited by the content of these embodiments. In addition, the above-described components include those that can be easily assumed by those skilled in the art, those that are substantially the same, and those in a so-called equivalent range. Furthermore, the above-described components can be appropriately combined. Furthermore, various omissions, substitutions, or changes in the components can be made without departing from the gist of the above-described embodiments.

Among the processes described in the above embodiments, all or some of the processes described as being performed automatically can be performed manually, or all or some of the processes described as being performed manually can be performed automatically by a known method. In addition, the processing procedure, specific name, and information including various pieces of data and parameters illustrated in the above document and the drawings can be changed in any manner unless otherwise specified. For example, the various types of information illustrated in each figure are not limited to the illustrated information.

In addition, each component of each device illustrated in the drawings is functionally conceptual, and is not necessarily physically configured as illustrated in the drawings. That is, a specific form of distribution and integration of each device is not limited to the illustrated form, and all or part thereof can be functionally or physically distributed and integrated in any unit according to various loads, usage conditions, and the like.

For example, the above-described server device 100 may be implemented by a plurality of server computers, and depending on functions, the configuration can be flexibly changed so that an external platform or the like is referred to by an application programming interface (API), network computing, or the like to be implemented.

In addition, the above-described embodiments and modifications can be appropriately combined within a range that does not contradict processing content.

In addition, the “section, module, unit” described above can be read as “means”, “circuit”, or the like. For example, the acquisition unit can be replaced with an acquisition means or an acquisition circuit.

According to an aspect of the embodiment, user data can be shared on a data card between accounts.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device comprising:
an issuance processing unit that provides a function of issuing a data card that allows another account to use the data related to a user of an account, to the account to be an issuer of the data card;
a management unit that provides the user with a function of managing a wallet that stores the issued data card; and
a verification processing unit that provides a function of verifying the data card to another account to be presented with the data card by the user and to be a verifier of the data card.

2. The information processing device according to claim 1, further comprising:
a presentation processing unit that formats and presents data of a data card in accordance with a verifier when the user presents the data card stored in the wallet to the verifier.

3. The information processing device according to claim 2, wherein
the presentation processing unit partially hides, partially blurs, or integrates data when formatting the data.

4. The information processing device according to claim 1, wherein
the management unit receives an operation on the data card stored in the wallet from the user, and performs any of browsing, deleting, issuing, and data formatting of the data card according to the operation by the user.

5. The information processing device according to claim 1, wherein
the management unit stores raw data of the data card in the wallet.

6. The information processing device according to claim 5, wherein
the management unit further stores encrypted data of the data card on a cloud.

7. The information processing device according to claim 1, wherein
when an account of a public institution including a local government issues a data card, the issuance processing unit provides a function of issuing the data card including an issuer, data indicating a name and an address of the user, and a trust mark.

8. The information processing device according to claim 1, wherein
the issuance processing unit issues a data card using any of a plurality of templates according to a stage of an abstraction level of the data card.

9. The information processing device according to claim 1, wherein
the issuance processing unit provides a function of issuing a data card that is a group card shared by a plurality of users belonging to a same group to an account of a store such as a restaurant.

10. The information processing device according to claim 1, wherein
the verification processing unit provides a function of performing temporary authentication with another data card that is not a data card to be originally targeted, and verifying the target data card later to another account to be a verifier of the data card.

11. An information processing method executed by an information processing device, the method comprising:
providing a function of issuing a data card that allows another account to use the data related to a user of an account, to the account to be an issuer of the data card;
providing the user with a function of managing a wallet that stores the issued data card; and
providing a function of verifying the data card to another account to be presented with the data card by the user and to be a verifier of the data card.

12. A non-transitory computer readable storage medium storing an information processing program for causing a computer to execute:
providing a function of issuing a data card that allows another account to use the data related to a user of an account, to the account to be an issuer of the data card;
providing the user with a function of managing a wallet that stores the issued data card; and
providing a function of verifying the data card to another account to be presented with the data card by the user and to be a verifier of the data card.
